(19) United States
(12) Patent Application Publication
(10) Pub. No.: US 2018/0078447 A1
(43) Pub. Date: Mar. 22, 2018

(54) Heated Rolling Massager

(71) Applicants: Victor Viner, Northfield, IL (US); David Carhart, Cary, IL (US); Gil Cavada, Wauconda, IL (US); Mark Schwartz, Wauconda, IL (US)

(72) Inventors: Victor Viner, Northfield, IL (US); David Carhart, Cary, IL (US); Gil Cavada, Wauconda, IL (US); Mark Schwartz, Wauconda, IL (US)

(21) Appl. No.: 15/639,352

(22) Filed: Jun. 30, 2017

Related U.S. Application Data
(63) Continuation-in-part of application No. 29/586,888, filed on Dec. 7, 2016.
Application No. 29/586,888 is a continuation-in-part of application No. 29/604,447, filed on May 17, 2017.
(60) Provisional application No. 62/357,873, filed on Jul. 1, 2016.
(60) Provisional application No. 62/431,400, filed on Dec. 7, 2016.

(51) Int. Cl. A61H 15/02

(52) U.S. Cl. CPC A61H 15/02; A61H 2201/0242; A61H 2201/0207

(57) ABSTRACT

A heated roller massager is disclosed, including a heating core and a multilayer structure including a conductive infused polymeric layer for delivering a therapeutic level of heat to a user.

### PRIORITY OF INVENTION

THIS APPLICATION CLAIMS PRIORITY TO APPLICATION NO. 62/357,873, FILED JUL. 1, 2016, APPLICATION NO. 62/431,400 FILED DEC. 7, 2016, APPLICATION NO. 29/586,888 FILED DEC. 7, 2016 AND APPLICATION NO. 29/604,447 FILED MAY 17, 2017.

### FIELD OF THE DISCLOSURE

The present disclosure relates generally to a heated roller massage assembly for delivering a therapeutic amount of heat to sore or injured muscles, or for improved relaxation and well-being. More specifically, the present disclosure is directed towards a device for delivering one of a dielectric (e.g., microwave) heated or otherwise heated fluid (such as air) from a core (which may be separable for ease of use in microwaving) to an outer wall or surface that contacts the user while modulating the delivery of heat from the heating element to the user.

### BACKGROUND OF THE INVENTION

Foam rollers may be therapeutically beneficial for alleviating muscle tightness and tension; however they may have limited efficacy without thermal capability. That is, the addition of thermal treatment can provide a more beneficial therapeutic experience.

Conventionally, one known method to achieve a heating effect while using a foam roller is the use of an electric heating element. However, such items may be limited by the need for proximity to an outlet, and may be further limited in the promptness (due to delays in the heating cycle) with which it is able to obtain the necessary level of heat for the user. Additionally, the thermal buildup of such heating elements could create undue heat and related discomfort to the user. Further, the presence of the heating element and its related components may create undue weight and complexity to the user which may be particularly unsuitable for travel and/or shipping.

Another known method to achieve heating therapy with a foam roller is the use of a heating pad with the roller. This approach would require a person to lay a bulky heating pad on top of the foam roller, and then balance on top of it. Rolling the heated portion through or near the muscle to be targeted would not be possible because the pad would fall off as the roller turns. Additionally, the bulkiness of the pad would at best be uncomfortable, and possibly prohibit the benefit of the direct pressure from the roller applied to the targeted muscle.

Alternatively, there exist other approaches which teach placing a massage ball or similar product in boiling water or a microwave for heating prior to be applied to a user. However, such approaches present difficulties such as: 1) the difficulty in handling or applying such a product to a user's skin upon heating; 2) a limitation in size or volume of the ball to fit more compact microwaves; and 3) difficulties with modulating the delivery of heat such that the surface is unable to absorb heat quickly for use while also providing a slow dissipation of heat for delivery to a user.

To date, Applicant is aware of no products which provide a lightweight thermal roller assembly with a configuration for the quick heating and modulated delivery of a therapeutic level of heat to the roller surface for application to the user.

What is needed is a mechanism for a compact, reliable, lightweight, non-electric heating mechanism for promptly delivering a prolonged yet modulated therapeutic level of heat to the surface of a roller for application to a user.

### DEFINITION OF TERMS

The following terms are used in the claims of the patent as filed and are intended to have their broadest plain and ordinary meaning consistent with the requirements of the law:

A fluid heat source means, an air, water based or gel based fluid (e.g., a polypropylene gel) or similar liquid for providing heat (whether from boiling, microwaving or a chemical table/exothermic reaction) for enabling a thermal transfer to the outer surface of the assembly.

A “release mechanism” is one or more physical structures (e.g., a locking mechanism in the segments of the core, a cap in the outer wall, and/or a water bottle insertable into the assembly, and/or a spout in the water bottle) whereby: 1) the bottle can be disassembled into segments and/or 2) the heat source can be removed or inserted by the user.

An “inner wall” refers to at least a portion of a water bottle or liquid packet which may be removed for heating and subsequent insertion.

A therapeutically effective amount of heat comprises a temperature of at least 105F. on the surface of the outer wall for at least 10 minutes when timed after insertion or generation of the chemical heat source heating the inner wall for a range of 2 to 5 minutes, and preferably at least 115F. on the surface of the outer wall for at least 10 minutes, when timed after insertion or generation of the chemical heat source heating the inner wall for a range of 2 to 5 minutes.

Where alternative meanings are possible, the broadest meaning is intended. All words used in the claims set forth below are intended to be used in the normal, customary usage of grammar and the English language.

### SUMMARY OF THE INVENTION

The present invention relates to one or more of the following features, elements or combinations thereof.

One disclosed embodiment is directed to the use of a bottle holding air that may be broken into two separate segments that may be connected with a locking mechanism. The assembly includes an inner layer made of a softer plastic material such as polypropylene, and an outer layer that includes and a second outer layer, such as an overmold that includes an Thermoplastic Elastomer, such as Santoprene or TIPSiV, wherein such outer layer can include a powdered metallic mater or carbon black or the like in a range of 10-30% so as to create a microwave absorbable material. This embodiment is believed to provide an assembly with superior performance for absorbing microwave thermal energy quickly, while at the same time providing a slow thermal bleed so as to enable delivery of a therapeutically effective amount of heat to the user. As a further option, this embodiment can be can also include the use of a matrix or lattice in the otherwise air filled core inside so as to improve the performance of the thermal bleed.

A second disclosed embodiment is directed to the use of a heated roller assembly. The assembly includes an inner or second layer which may be a water bottle made of a softer material (such as silicone). The second or inner layer is insertable into an outer shell that provides a modulated delivery of heat to a user. Specifically, this embodiment includes a first or outer layer of hardened plastic (such as HDPE), preferably with an over-mold of a thermoplastic elastomer (TPE) mixed with a conductor such as graphite or a powdered alloy. The use of graphite, iron, copper, ceramic or similar conductive alloy within the overmold is believed to provide a thermal bleed or modulated delivery of a therapeutic amount of heat to the outer surface of the assembly for delivery to a user.

A third disclosed embodiment comprises other form factors (such as a neck bolster, a heatable therapeutic ball or the like) in which the inner layer can comprise a thermoplastic elastomer (such as polypropylene) which can include carbon black in a range of 10-30% and optionally a foaming agent, and in which the outer layer comprises a thermoplastic elastomer such as Santoprene or TIPSiv to provide a softer material for improved comfort in application.

Thus, it can be seen that one object of the disclosed invention is to provide a roller assembly with an air fluid medium, and separable top and bottom components to make a more compact roller for heating in a microwave or the like.

Another object of the disclosed invention is to provide a roller assembly with a mechanism enabling its quick heating while limiting dissipation in a sustained, controlled release of a therapeutic amount of heat to a user.

A further object of the present invention is to provide a roller assembly with a removable heating insert for enabling the dielectric heating of a roller assembly where the roller assembly has a larger volume than the microwave unit energizing the heating insert.

Still another object of the present invention is to provide heated roller assembly that can be heated in the absence of electricity that uses a collapsible heating insert that minimizes weight and volume demands, while still providing a rigid outer surface that enables a therapeutic massage to a user.

Yet another object of the present invention is to provide a mechanism for a quicker and improved combined delivery of heat therapy and massage therapy to a user.

It should be noted that not every embodiment of the claimed invention will accomplish each of the objects of the invention set forth above. For instance, certain claimed embodiments of the invention will not employ a water bottle, per se, but rather may involve sealed packages of water or gel to deliver a therapeutic amount of heat to the surface of the assembly for application to the user. In addition, further objects of the invention will become apparent based upon the summary of the invention, the detailed description of preferred embodiments, and as illustrated in the accompanying drawings. Such objects, features, and advantages of the present invention will become more apparent in light of the following detailed description of various preferred embodiments thereof, and as illustrated in the accompanying drawings.

### BRIEF DESCRIPTION OF THE DRAWINGS

FIG. 1 is an exploded perspective view of a heated water bottle assembly in accord with a preferred embodiment of the present invention;

FIG. 2 is a side cross-sectional view of the heated water bottle assembly in accord with the preferred embodiment shown in FIG. 1;

FIG. 3 is a side view of a water bottle in accord with the preferred embodiment shown in FIG. 1;

FIG. 4 is a perspective view of a bottle for air or another fluid in accord with another preferred embodiment of the present invention;

FIG. 5 shows a disassembled side view of the bottom and top segments, respectively of the preferred embodiment shown in FIG. 4;

FIGS. 6a and 6b show cut a away perspective view of the bottom and top segments, respectively of the preferred embodiment shown in FIG. 4.

FIG. 7 shows a perspective view of a heatable therapeutic ball in accord with another preferred embodiment of the present invention;

FIG. 8 shows a top view of a heatable therapeutic ball in accord with another preferred embodiment of the present invention;

FIG. 9 shows a side view of a heatable therapeutic ball in accord with another preferred embodiment of the present invention; and

FIG. 10 shows a perspective view of a heatable neck bolster in accord with another preferred embodiment of the present invention.

### DETAILED DESCRIPTION OF EMBODIMENTS OF THE INVENTION

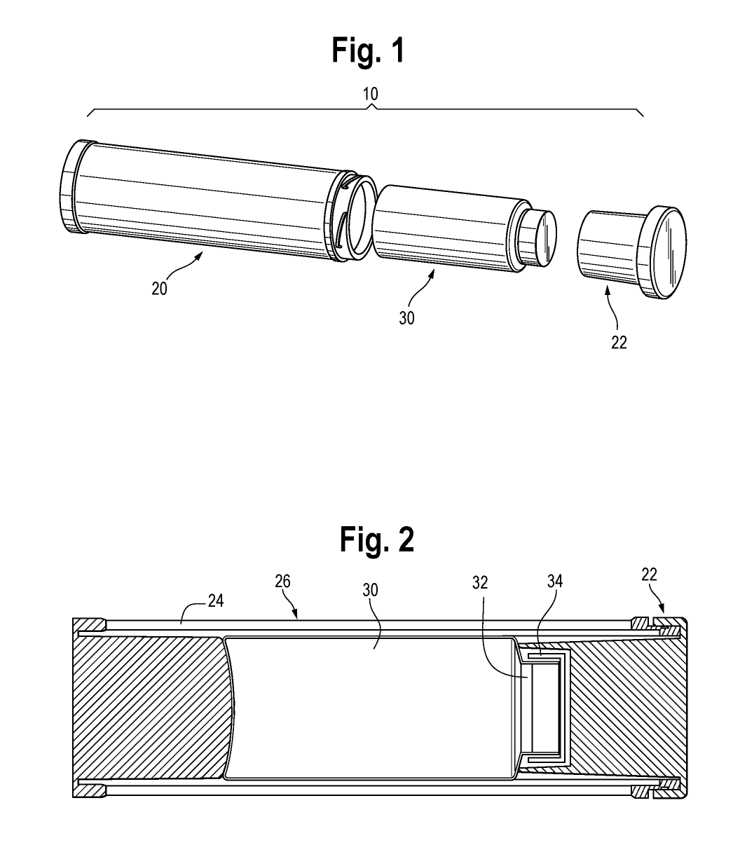

As can be seen in FIG. 1, one embodiment of the present invention comprises a heated roller assembly 10 for supplying heat therapy and massage therapy to a user. It is contemplated that the assembly a first or outer wall 20 which is generally cylindrical in shape, with at least one open end that may be covered by a cap 22 that can be unscrewed or unsnapped to allow for easy removal and reinsertion of the water bottle. Inserted with the outer wall 20 during normal operation is a removable water bottle 30. Most preferably, the water bottle 30 of this embodiment may further include a sealable spout 32 or opening which allows the water bottle to filled by water or a similar heating fluid, such as a polypropylene based gel.

The water bottle is most preferably of small enough dimensions to be placed in the smallest of standard microwave oven chambers, although those of skill in the art will understand that the water bottle 30 of the present invention may likewise be heated by other non-electric energy sources besides dielectric (microwave) heat mechanisms, such as boiling water and even chemical tablets for implementing an exothermic reaction. Additionally, those of skill in the art will understand that the water bottle 30 may be composed of silicone or a similar, soft or rubberlike material that allows the safe retention of the heated water or similar heated liquid energy source.

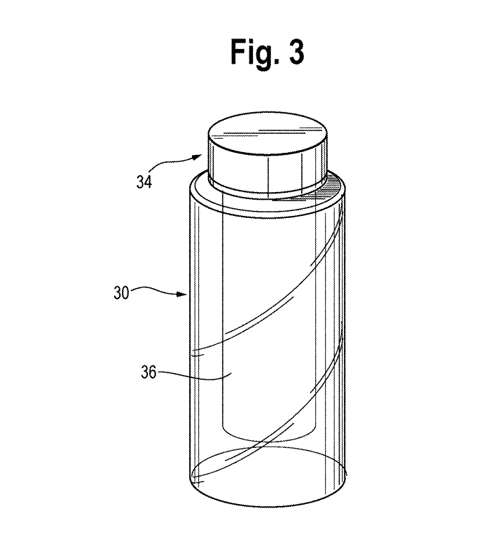

Variants of the first or outer wall 20 are shown in FIGS. 2 and 3. In a first preferred embodiment as shown in FIG. 2, the outer wall 20 includes a inner thermoplastic layer 22 preferable made of a rigid, strong yet lightweight material, such as HDPE mixed with a conductor such as graphite or a powdered alloy. Also included in this embodiment is a outer thermoplastic layer 24 made of a thermoplastic elastomer. An example of this mixture may be found, for example in Santoprene, PRE-ELEC 1502 or in Preseal® TPE 5010, or which is available through Premix Thermoplastics, Inc. This second thermoplastic layer is overmolded onto the surface of the inner thermoplastic, and the graphite or metallic coated graphite or similar conductor in the first layer better enables the quick and controllable conduction of heat from the water bottle 30 through the insulative HDPE layer of the inner layer 22 to be relayed to the user for heat therapy to remedy sore or hurt muscles and the like, while enabling a softer rubber like outer surface for providing better massage therapy to a user.

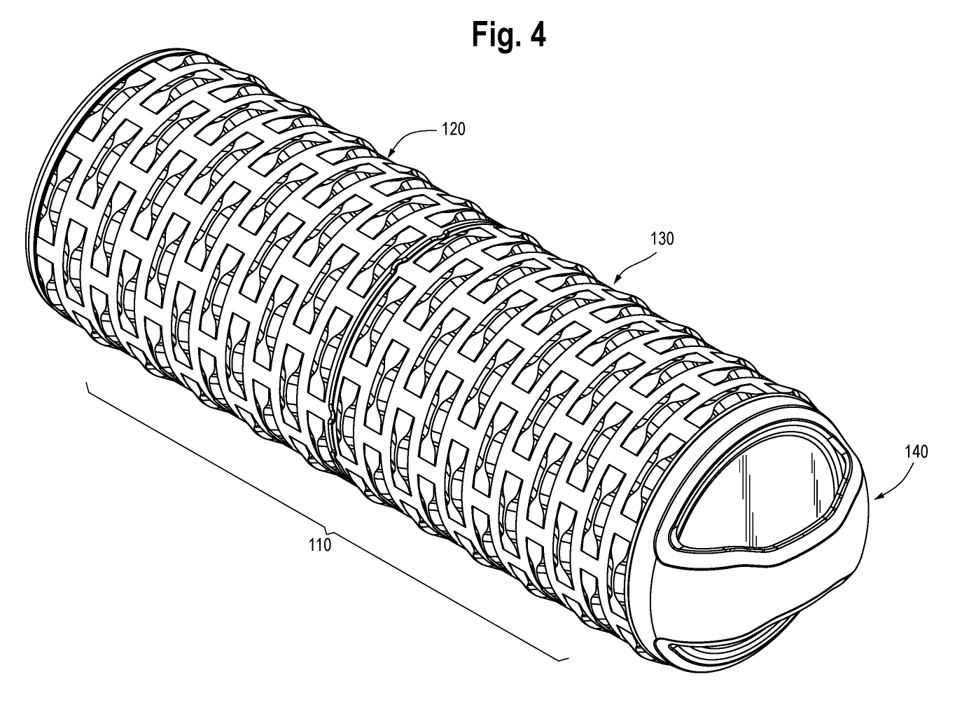

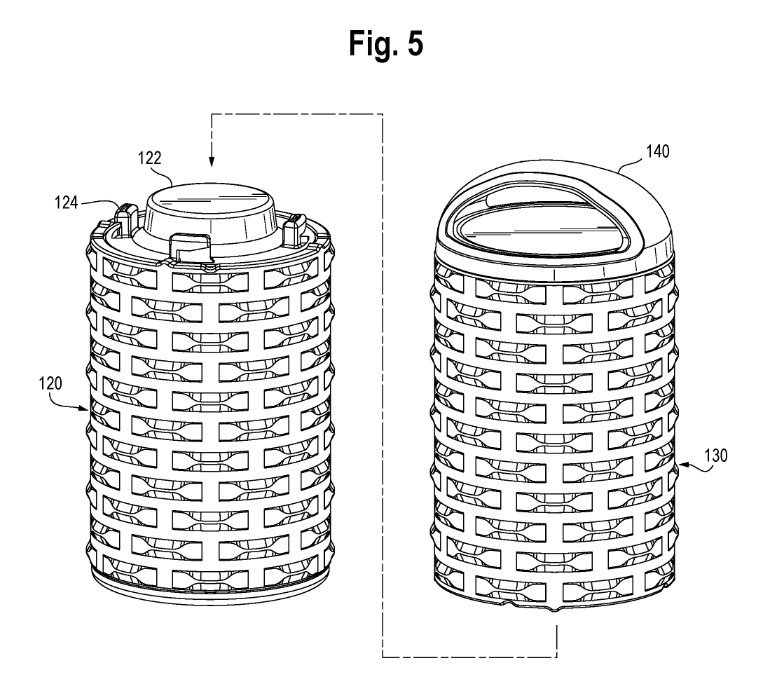

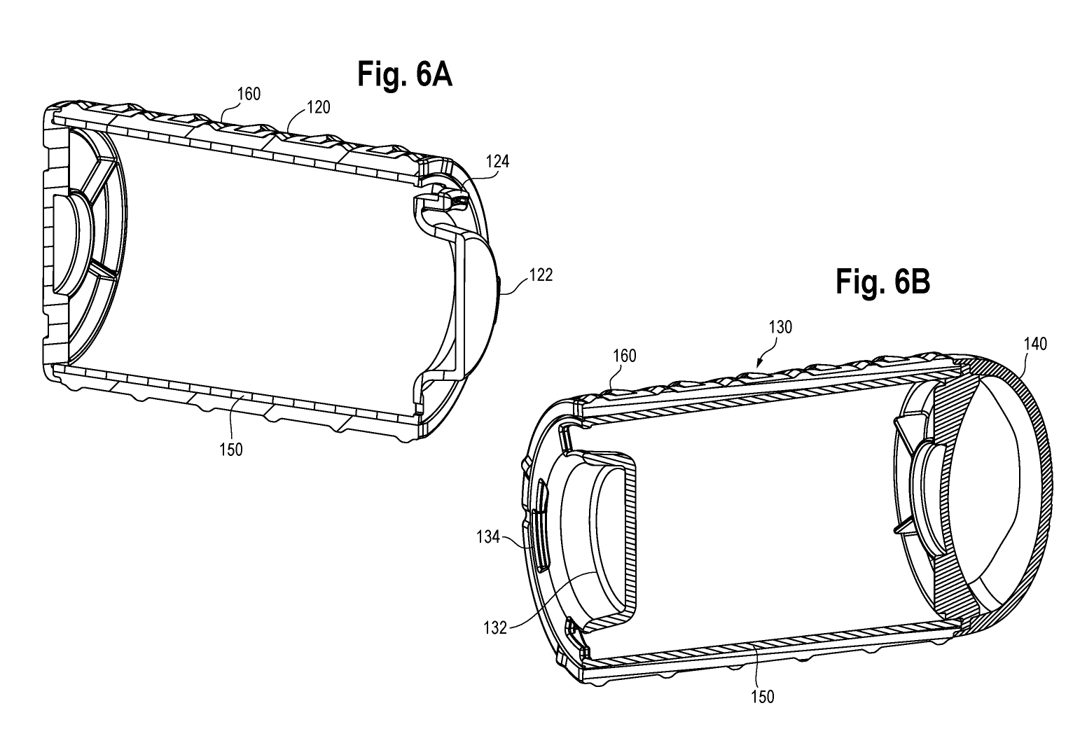

FIGS. 4-6 show another preferred embodiment of the present invention which may have further advantages with certain fluids for heating such as air. In this preferred embodiment, the bottle assembly 110 is comprised of bottom 120 and top 130 segments, with the top segment 130 including a handle for convenient carrying. The bottom 120 preferably includes a protrusion 122 that mates with a corresponding recess 132 in the top 130. People of skill will understand that the protrusion and detent may be swapped such that the protrusion is found in the top 130, though having the recess in the top provides the additional advantage of a more stable, flat surface for placing in a microwave or the like. In addition, the bottom 120 includes a series of hooks 124 that mate with slots 134 in the top such that the two segments may be locked together through insertion and a twisting motion. As with the recess and protrusion, the location of the hooks and the slots may be switched as desired, though placing the slots 134 in the top 130 rather than the bottom again provides a more stable surface for placement in a microwave. As a result, this embodiment 110 provides a convenient lock for disassembling the roller into 2 compact pieces for stable placement in even the smallest of microwaves.

This preferred embodiment, unlike the earlier described embodiment does not include a separate water bottle, although like that earlier embodiment, the assembly can include multiple layers or components. For instance, this assembly can include an inner layer 150 and an outer inner 160. The inner layer 150 or core preferably includes a thickness of between about 1/16″-½″ of polypropylene or similar material with about 10-30% carbon black and/or a similar metalloid, with an outer layer that is a mixture of Santoprene and/or a similar thermoplastic elastomer which may or may not have carbon black so as to absorb microwave energy to the inner layer 150 and the hollow core of air defined by the inner layer. Alternatively the core may include a lattice or honeycomb (not shown) so as to further improve heat retention. The combination of these layers and their varying thermal coefficients are thus believed to provide for the quick accumulation of microwave energy to heat the air fluid core, while still slowly bleeding that thermal energy back from the inner layer 150 to the outer layer 160 so as to provide a modulated delivery of a therapeutic level of heat to the roller surface for application to the user.

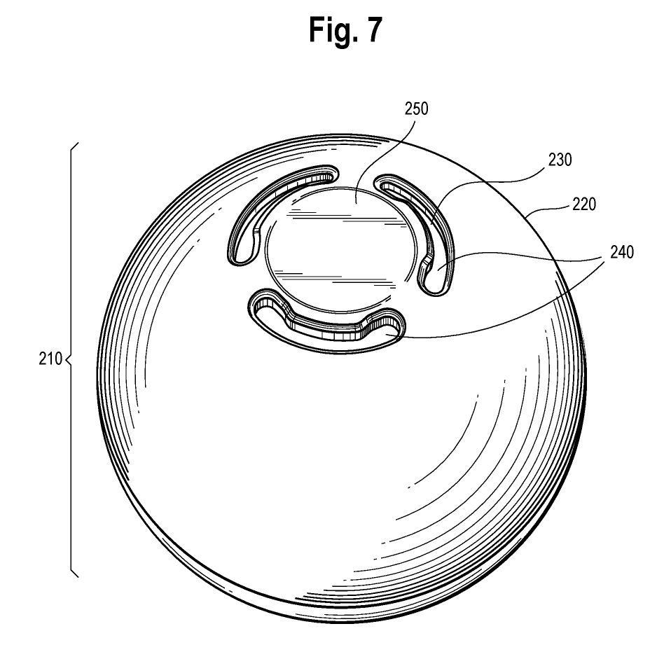

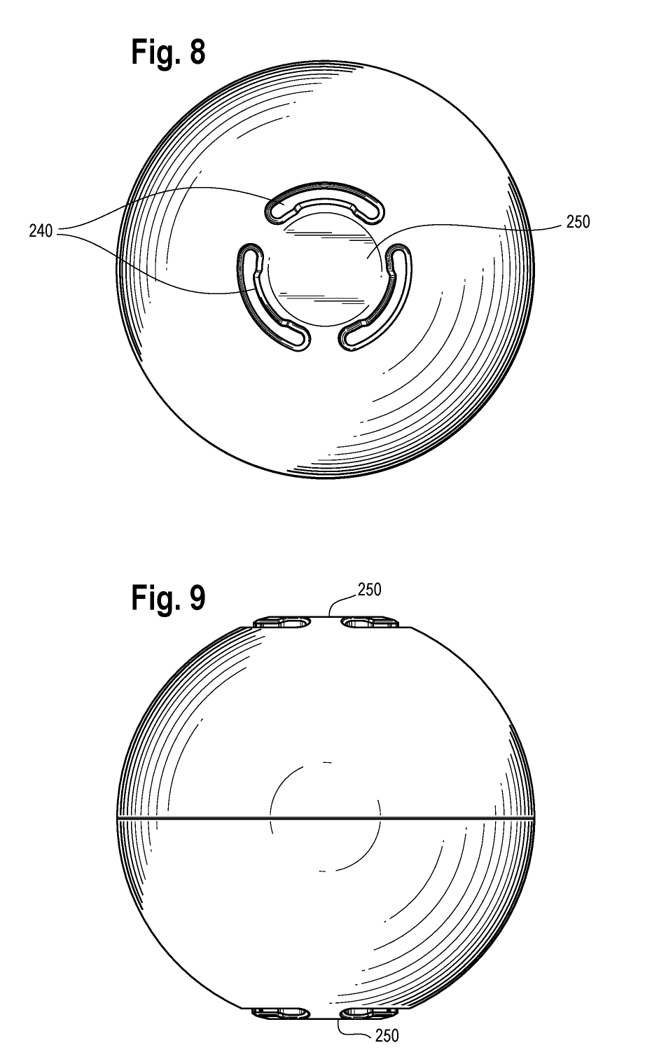

Still a further alternative for the present invention is shown in the drawings of FIGS. 7-9. This embodiment, like the embodiment of FIGS. 4-6, does not require a water bottle or other fluid than air. This embodiment, however, involves a microwave heatable therapeutic ball 210, that includes an outer layer 220, which may be an outer layer or overmold of Santoprene of a thickness of about ⅛″-¼″, and an inner layer 230 comprised of polypropylene or similar material containing about 10-30% carbon black, wherein the inner layer that may also include or be comprised of a foaming agent to reduce weight and to improve heating performance characteristics, such as the heating profile performance of the ball in use. The ball 210 may further include vents 240 and champfered or flattened ends 250 to support stability when placed in a microwave for heating.

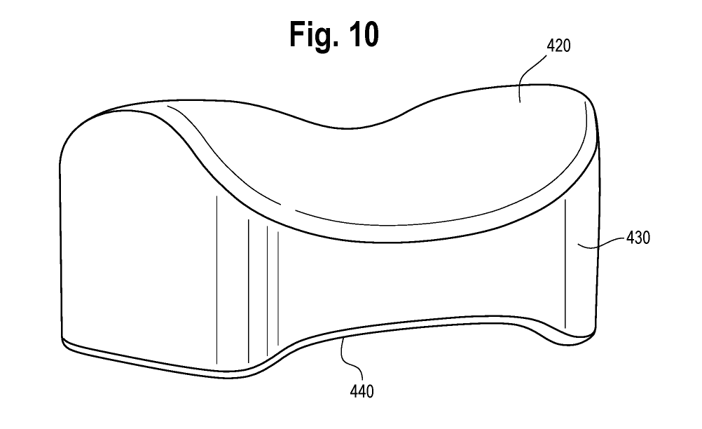

Yet another alternative embodiment for the present invention is shown in the neck bolster embodiment displayed in FIG. 10. In this embodiment, the bolster 310 is comprised of a heating pad 320 and feet 340, wherein these components comprise an overmold of Santoprene or a similar structure that sandwiches a heating block 330 which is comprised of polypropylene of the like and about 10-30% carbon black. The bolster 310, like the other form factors described above, are designed to be used with a microwave heating process for a short time frame (e.g., 60 seconds) while providing a controlled release of a therapeutic amount of heat over a much longer timeframe.

While the disclosure is susceptible to various modifications and alternative forms, specific exemplary embodiments thereof have been shown by way of example in the drawings and have herein been described in detail. It should be understood, For instance, there is a number of variants on the “water bottle” embodiment that could include sealed or unsealed packet containing a variety of different fluids to be processed, and the invention may apply with equal force to other form factors, including but not limited to balls on a platform (e.g., for massage bar), neck wraps, and even other, non-massage applications. There is no intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A therapeutic heated roller comprising:
a) A chemical heat source;
b) At least one conductive infused inner wall for providing thermal conductivity from the heat source;
c) A outer insulative polymeric layer for modulating the heat from the at least one inner wall and delivering a therapeutically effective amount of heat therefrom to a user; and
d) A release mechanism whereby the heat source can be removed or inserted by the user.

2. The roller of claim 1, wherein the release mechanism comprises a second inner wall in immediate contact with the heat source, the second inner wall forming a container to enable removal of the heat source from the roller.

3. The roller of claim 1, wherein the at least one inner wall is HDPE infused with carbon black in an amount of 10-30%.

4. The roller of claim 2, wherein the second inner wall is silicone.

5. The roller of claim 1, wherein the chemical heat source is water.

6. The roller of claim 1, wherein the chemical heat source is a polypropylene based gel.

7. The roller of claim 1, wherein the conductive infused outer insulative polymeric layer comprises Santoprene and graphite.

8. The roller of claim 1, wherein a therapeutically effective amount of heat comprises a temperature of at least 115F. for at least 10 minutes.

9. A therapeutic heated roller comprising:
a) A fluid heat source;
b) A top segment and a bottom segment, each of the top and bottom segments including: i) at least one inner wall for providing thermal conductivity from the fluid heat source; and ii) A conductive infused outer insulative polymeric layer for modulating the heat from the at least one inner wall and delivering a therapeutically effective amount of heat therefrom to a user; and
d) A release mechanism whereby the top and bottom segments may be connected.

10. A method for providing a therapeutic heat application comprising:
a) heating an assembly including a conductive infused heatable layer, and an insulative polymeric layer for a period of no more than two minutes in a dielectric heating device; and
b) contacting the conductive infused outer insulative polymeric layer to a user so as to deliver a therapeutically effective amount of heat.
